(19) United States
(12) Patent Application Publication
(10) Pub. No.: US 2002/0072347 A1
(43) Pub. Date: Jun. 13, 2002

(54) System and method of receiving specific information at a mobile terminal

(76) Inventors: Greg A. Dunko, Cary, NC (US); Jonathan Charles Lohr, Raleigh, NC (US)

Correspondence Address: COATS & BENNETT, PLLC, P O BOX 5, RALEIGH, NC, 27602, US

(21) Appl. No.: 09/732,403

(22) Filed: Dec. 7, 2000

(51) Int. Cl. H04Q 7/20

(52) U.S. Cl. 455/404; 455/414; 455/466

(57) ABSTRACT

A system and method of receiving specific information at a mobile terminal from a help server. The mobile terminal sends a request to the help server that includes at least one context sensitive datum. The help server receives the request and obtains a reply based on the context sensitive data. The reply is then sent to the mobile terminal where it is communicated to a user. In one embodiment, a help request may be sent from the mobile terminal as the user is in need of specific help in overcoming a problem.

### BACKGROUND OF THE INVENTION

Many mobile communications devices currently being built contain a mobile internet application that allows users to “surf” the mobile internet via a browser built into their mobile device. Through this browser, a user may obtain information such as stock quotes or directions to a restaurant, etc. The mobile aspect of the device combined with the ability to access the internet is one reason why these devices are so popular. Accessing information via the internet also provides additional avenues for the device manufacturer to supply the device user with information.

Mobile devices have evolved from simple units that support basic voice calls to complex communications devices which include personal information managers (PIMs), messaging capabilities (such as SMS or email), games, multimedia players, and other high level applications. The use of even these sub-components such as PIM (with phonebook, calendar, calculator, etc) are highly complex and require detailed knowledge of operation. With the evolution to more complex devices, the need for help and references is increased. For example, a typical PIM comes with a several-hundred page Users Guide/Handbook.

The user of these ever-more complex communications devices is increasingly likely to require access to “help” or to a User's Guide. Many mobile communications devices now include some limited help functions. In some devices, help is obtained by selecting a tab in a menu that invokes a short help phrase to identify the tab function. However, this help is limited and may not be sufficient to satisfy detailed questions about complex operations of the device. Typically then, the user must refer to a User's Guide to obtain this detailed information. Unfortunately, it is somewhat inconvenient to “carry” a User's Guide and so this is frequently unavailable to the mobile user.

Other applications may allow the device user to access a table of contents that lists all the information contained within. Unfortunately, the table of contents is time consuming to peruse, and a user often only needs information on one specific aspect of the device and would rather not be exposed to all the information available on the device.

The smaller sizes and desire for low-cost instruments have both added to a problem of limited memory and processing capability at the mobile terminal. Therefore, the mobile terminal is only able to store a limited amount of information and additional computing capacity must be obtained by alternate means. It is advantageous for additional memory and computing capacity to be accessed by the mobile terminal from a remote source.

### SUMMARY OF THE INVENTION

The present invention is directed to a system and method of sending specific context sensitive data to a server and receiving specific information back from the server. One method includes detecting a help trigger event at the mobile terminal and formulating a help request. The help request includes context sensitive data associated with a current status of the mobile terminal. Once the help request is formulated, it is sent to a remote help server via an RF link. The mobile terminal then receives help information from the remote help server that is based on the context sensitive data.

The triggering event may be detected at the mobile station in a variety of manners including the user inputting the request by actuating a function key, or via a voice command. The help request may include each of the applications that is active within the mobile terminal, or may be only the most recently accessed application. Additionally, the help request may include the language, model number, and software version of the mobile terminal.

One specific aspect of the invention comprises obtaining specific data at a mobile terminal from a remote user's manual maintained on a help server. A help request is received regarding a specific aspect of the mobile terminal. Context specific data is collected at the mobile terminal regarding the specific aspect. Based on the context specific data, the mobile terminal obtains help information at the help server from a specific section of the user's manual which is then communicated to the user.

### BRIEF DESCRIPTION OF THE DRAWINGS

FIG. 1 is a perspective view of one embodiment of a mobile terminal used with the present invention;

FIG. 2 is a schematic diagram illustrating the elements of a mobile terminal in accordance with one embodiment of the present invention;

FIG. 3A is a schematic diagram illustrating a mobile terminal accessing a remote help server via a base station;

FIG. 3B is a schematic diagram illustrating a mobile terminal accessing a help server integrated with an MSC via a base station;

FIG. 4 is a flowchart diagram illustrating the steps of receiving specific information at the mobile terminal in accordance with one embodiment of the present invention;

FIG. 5 is a schematic diagram illustrating a path of communication between the client and help server featuring a gateway serving as an intermediary; and

FIG. 6 is a schematic diagram illustrating a path of communication between the client and help server wherein the help server is integrated with the MSC.

### DETAILED DESCRIPTION OF THE INVENTION

The present invention is directed to a system and method of receiving specific information at a mobile terminal 10 from a help server 50. The mobile terminal 10 sends a request to the help server 50 that includes at least one context sensitive datum. The help server 50 receives the request and obtains a reply based on the context sensitive data. The reply is then sent to the mobile terminal where it is communicated to a user. In one embodiment, a help request may be sent from the mobile terminal 10 as the user is in need of specific help in overcoming a problem.

The ability of the mobile terminal 10 to deliver context sensitive data to the help server 50 allows for more specific information to be returned to the user. The help server 50 is able to receive the request and the context sensitive data and find information beyond the superficial level that would be otherwise accessed. By way of example, a generic request for help regarding an application from the device 10 to the help server 50 may cause the help server 50 to send a table of contents from a user guide to the user. The user must then delve through the information and find the pertinent information necessary regarding the specific application. With the present invention, context sensitive data to the help server 50 allows for specific information on the application to be initially sent to the user.

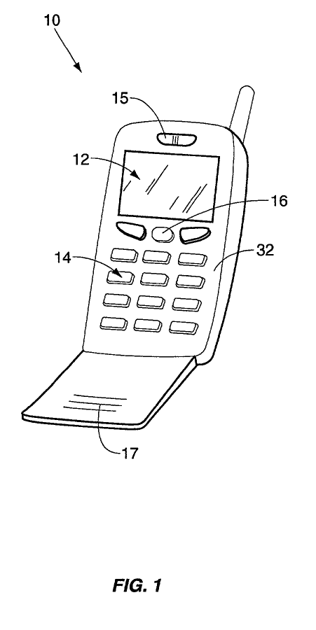

The present invention is applicable in a variety of mobile terminals, generally denoted 10, such as that illustrated in FIG. 1. The mobile terminal 10 includes a display assembly 12 for displaying characters input and/or received by the user. Input keys 14 are positioned adjacent to the display assembly 12 for inputting and controlling the function of the device 10. Input keys 14 may include specific characters such as numbers and letters, or may represent control functions such as “enter”, “on”, “off” and the like for controlling the device 10. A function key 16 may provide direct access to the help server 50 when actuated by the user. An outer housing 32 extends around the display assembly 12 and input keys 14. The embodiment illustrated in FIG. 1 is a portable cellular telephone that further includes a speaker 15 and microphone 17 for the user to partake in audible communications.

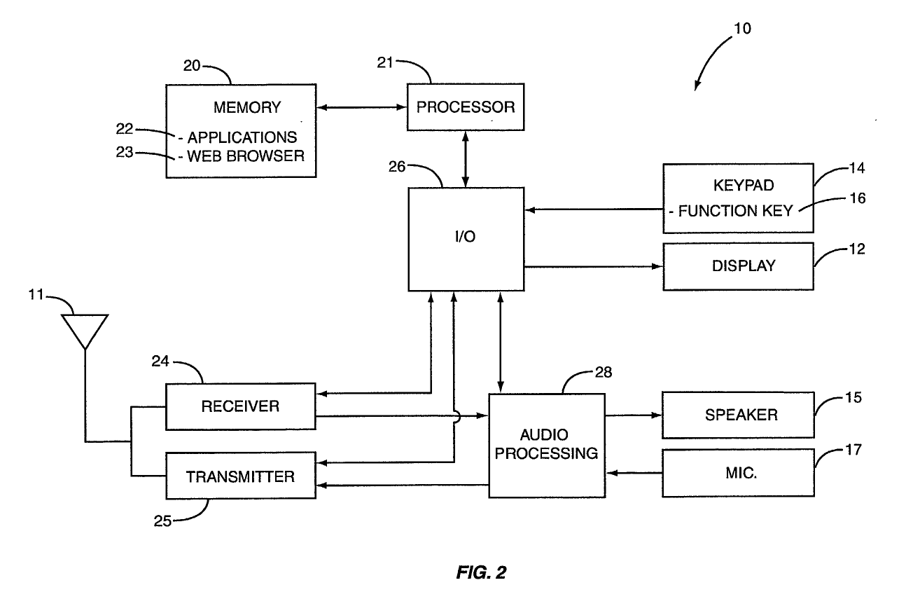

FIG. 2 is a block diagram of a typical mobile terminal 10. The disclosed embodiment of the mobile terminal 10 is a fully functional cellular telephone capable of transmitting and receiving signals. The mobile terminal 10 comprises a main processor 21 for controlling the overall operation of the mobile terminal 10. Memory 20 is operatively connected to the processor 21 for storing applications 22 used by the mobile terminal 10 during operation. Examples of applications 22 may include voice mail, phone book, ringing features such as sound and vibrate modes, speed dial, etc. Memory 20 may also contain specific information about the mobile terminal 10 including the software version of the applications 22, model number, and language. A web browser application 23 may further be stored within memory 20.

Input/output circuits 26 interface the processor 21 with the keypad 14, display 12, and audio processing circuits 28. A receiver 24, and transmitter 25 are operatively connected to antenna 11 for sending and receiving communications via a wireless communication network 60.

During operation of the mobile terminal 10, processor 21 may monitor the status of each application 22 and note which is currently active. By way of example, a status check may indicate that the user is currently using the “phone book” and “voice mail” applications. Once the user closes the phone book application, the status check then indicates that only the voice mail application is active. In another embodiment, processor 21 may maintain a log of the status of each individual application. Thereby, a timeline of the function of each of the applications 22 may be created. The status check may be permanently maintained within memory 20 or updated and purged as necessary. In another embodiment, processor 21 may take a “snapshot” of the status of the applications 22 when requested. By way of example, when the user actuates the function key 16, processor 21 determines the status of each application 22.

Applications 22 may further be designed such that a specific application state may be determined by the processor 21. The application state is a more specific determination of the exact aspect of the application that may be in question. By way of example, the “voice mail” application may be open which includes a plethora of subtopics. If the processor 21 is able to determine that the application state is accessing stored numbers from the phone book, more specific help information can be obtained than if more generic request for application information is sent to the server 50.

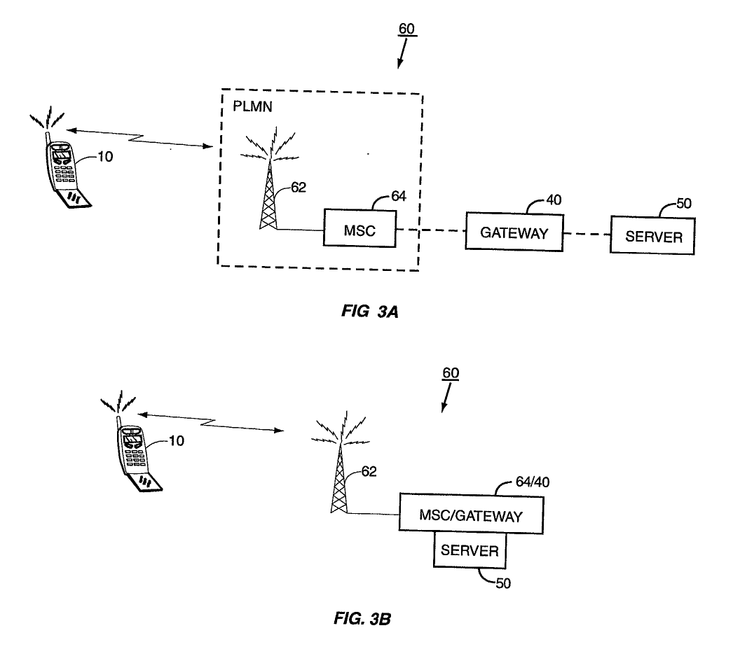

The interaction between the mobile terminal 10 and server 50 may be via the wireless communication network 60 as schematically illustrated in FIGS. 3A and 3B. In a first embodiment (FIG. 3A) the wireless communication network 60 may comprise a base station 62 communicatively coupled to one or more Mobile Switching Centers (MSCs) 64. Collectively, the base stations 62 and MSCs 64 comprise the Public Land Mobile Network (PLMN) and may operate according to any number of published standards such as TIA/EIA-136, IS-95, AMPS, D-AMPS, CDMA, wCDMA, GSM, or the like. As these standards are the subject of extensive documentation and commentary, a further discussion will be omitted. MSC 64 may further communicate to gateway 40 which then forwards the information to a remote help server 50. This communication may be over the Public Switch Telephone Network (PSTN), Internet, a dedicated line, a wireless connection or the like. This communication between the MSC 64 and the help server 50 may take a number of forms, but in an exemplary embodiment comprises a TCP/IP or HTTP style communication.

In an alternate embodiment illustrated in FIG. 3B, the help server 50 is integrated with the MSC 64 and the gateway 40 or closely associated therewith such as a Home Location Register (HLR) or Visitor Location Register (VLR) might be associated with the MSC 64.

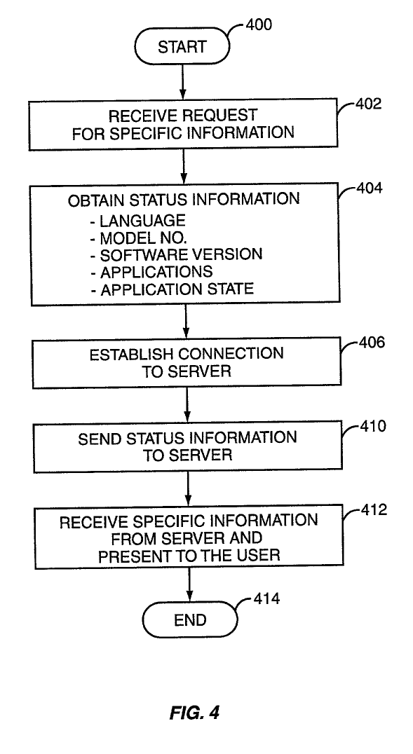

FIG. 4 illustrates the steps of one application of the present invention in which the mobile terminal user requires help regarding a specific application 22. The process starts (block 400) with the device 10 being utilized by a user. At some point during use, a request is received by the device for specific information (step 402). The request may take a variety of forms including the user depressing the function key 16, or a voice command such as a keyword “help” spoken into the microphone 17. Other manners of indicating the need for information may also be used and considered within the scope of the present invention.

Upon receiving the request, the mobile terminal 10 obtains the current status information (step 404). In one embodiment, processor 21 may maintain an on-going log of the status activity in which case the log information is simply forwarded at the time of the request. In another embodiment, processor 21 obtains the status only after a request has been received. In either embodiment, the status information may comprise the model number, software version, language, each open application, and the application state. The status information may also include error messages that have occurred within a given time period. In another embodiment, status information includes the application 22 that is mostly recently accessed by the user. By way of example, if the user has both voice mail and phone book applications open but is currently working with the voice mail application, only the voice mail application will be included with the other status information.

Once the status information is obtained, a connection to the help server 50 is established (step 406). All or part of the specific status information may be forwarded to the help server 50. The connection may include an intermediary connection through gateway 40, or may connect directly to the help server 50. Because the help server 50 has been supplied with additional information regarding the specific context of the application in question (step 410), more specific information may be obtained and sent to the client. In the example of the user requiring information regarding the voice mail application, several layers of information may be passed over and the specific information relevant regarding voice mail with the model number, software version, and language may be supplied.

Once the information has been sent back to the mobile terminal 10, it is communicated to the user (step 412) and the process ends (step 414). The information may be communicated to the user in a variety of formats including being displayed on display screen 12, or audibly communicated via speaker 15.

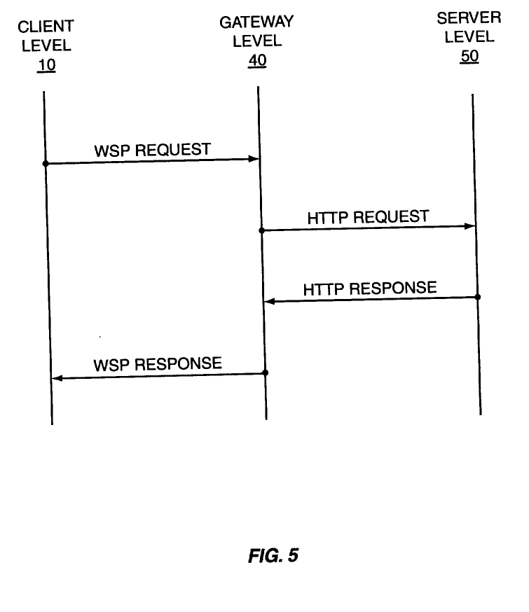

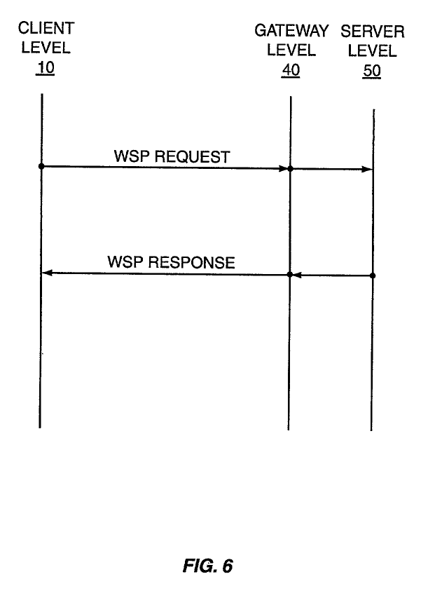

FIGS. 5 and 6 illustrate two embodiments of the mobile terminal 10 atthe client level communicating with the help server 50 at the help server level. FIG. 5 corresponds to the architecture of FIG. 3A. In FIG. 5, the device 10 sends a wireless session protocol (WSP) request to a gateway 40 (such as the MSC 64). This request contains the specific information needed by the help server 50. The WSP request comprises the uniform resource locator (URL) of the desired website of the help server 50, and status information such as device model number, language, open applications 22, and other information maintained by the processor 21 which may allow for specific information to be obtained at the help server 50. Gateway 40 parses the WSP request into a format accepted by the help server 50, and forwards the request. In an exemplary embodiment, the request is formatted as a hypertext transfer protocol (HTTP) request. The format may be arranged in a variety of manners, such as separate fields and/or headers.

The HTTP request with URL is received by the help server 50 and the specific reply information is accessed in an appropriate wireless markup language (WML). An HTTP response in WML is sent to the gateway 40 which compiles the information into a WSP response which may then be communicated to the user. In this embodiment, gateway 40 may be equipped with encoding, decoding, and protocol conversion algorithms for parsing and compiling the information as necessary.

In the architecture of FIG. 3B, the gateway 40 and the help server 50 are integrated to some extent because the MSC 64 acts as the gateway 40. As there is no communication to a remote help server 50, there need not be an HTTP request to the help server 50. Instead, the communication between the MSC 64 and the help server 50 could be through a bus architecture or the like as needed or desired. Further, the help server 50 could simply supply the information preformatted for wireless transmission from the MSC 64 to the mobile terminal 10 via the base station 62.

One application of the present invention is for a user's manual to be maintained at the help server 50. This is advantageous because the party supplying the information may maintain the help server information updated without specifically sending each user the updated information.

The term “help server” denoted by 50 used herein refers to a storage location for information that may assist the user in utilizing the device. Any authorized user may access this information. To overcome the limitation of limited memory size and processing capability of the mobile terminal 10, the help server 50 is capable of a large amount of data storage and higher processing capabilities.

Further, as used herein, the term “mobile terminal” 100 may include a cellular radiotelephone with or without a multi-line display; a Personal Communications System (PCS) terminal that may combine a cellular radiotelephone with data processing, facsimile and data communications capabilities; a Personal Digital Assistant that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals 100 may also be referred to as “pervasive computing” devices.

The present invention may be carried out in other specific ways than those herein set forth without departing from the scope and essential characteristics of the invention. In one embodiment, a security clearance may also be required prior to the device 10 obtaining service from the help server 50. Security may require that a password or other identification be supplied by the user prior to the connection being established. The present embodiments are, therefore, to be considered in all respects as illustrative and not restrictive, and all changes coming within the meaning and equivalency range of the appended claims are intended to be embraced therein.

1. A method of receiving help at a mobile terminal comprising the steps of:
detecting a help trigger event at the mobile terminal;
formulating a help request, said help request comprising context sensitive data associated with a current status of the mobile terminal;
sending said help request from the mobile terminal to a remote help server via an RF link; and
receiving help information from said remote help server at the mobile terminal, said help information being based on said context sensitive data.

2. The method of claim 1, wherein the step of detecting the help trigger event at the mobile terminal is selected from the group consisting essentially of receiving the help trigger event via a function key, and receiving the help trigger event via a voice command.

3. The method of claim 1, wherein the step of formulating a help request to said detecting said trigger event comprises determining an application that is active within the mobile terminal.

4. The method of claim 3, comprising determining the application most recently accessed by a user.

5. The method of claim 3, further comprising determining an application state of the application.

6. The method of claim 3, comprising determining improper activities.

7. The method of claim 1, wherein the context sensitive data is selected from the group consisting essentially of language, model number, and software version.

8. The method of claim 1, wherein the context specific information of the help request is obtained prior to the time the help request is received.

9. The method of claim 1, wherein the step of formulating the help request occurs after the help request is received.

10. A method of receiving information at a mobile terminal, the method comprising the steps of:
receiving a request for help regarding an application running on a mobile terminal;
gathering context specific data regarding the application;
sending the context specific data to a help server via an RF link; and
receiving a help response from the help server, the help response being based on the context specific data.

11. The method of claim 10, wherein the step of gathering context specific data regarding the application is performed prior to the time the request is received.

12. The method of claim 10, wherein the step of gathering context specific data regarding the application is performed after the request is received.

13. The method of claim 10, wherein the context specific data regarding the application is obtained from an activity log maintained at the mobile terminal.

14. The method of claim 10, wherein the step of sending the context specific data to the help server comprises accessing the help server through a gateway.

15. The method of claim 10, wherein at least a portion of the context specific data is selected from the group consisting essentially of a language, model number, and software version.

16. A method of accessing specific data at a mobile terminal from a remote user's manual accessed via an RF link through a help server, the method comprising the steps of:
receiving a help request at the mobile terminal from a user, the help request being directed to a specific aspect of the mobile terminal;
collecting context specific data regarding the specific aspect of the mobile terminal;
based on the context sensitive data, accessing help information at the help server from a specific section of the user's manual; and
communicating the help information to the user.

17. The method of claim 16, wherein the specific aspect of the mobile terminal is an application stored within memory.

18. The method of claim 17, wherein the context specific data is stored within memory.

19. A method of retrieving higher-level information from a remote help server having a plurality of information levels, said method comprising the steps of:
receiving a request for help at the mobile terminal;
formulating a help request, said help request comprising context sensitive data associated with a current status of the mobile terminal;
sending said help request from the mobile terminal to the help server via an RF link; and
receiving at the mobile terminal higher-level help information accessed from a higher information level at said remote help server, said higher-level help information being based on said context sensitive data.
